(19) United States
(12) Patent Application Publication
(10) Pub. No.: US 2026/0235194 A1
(43) Pub. Date: Aug. 13, 2026

(54) DIFFERENTIAL DEVICE WITH DISCONNECT

(71) Applicant: BorgWarner Sweden AB, Landskrona (SE)

(72) Inventors: Henrik WENDT, Furulund (SE); Karl WILSON, Kvidinge (SE); Patrik MALEK, Västra Frölunda (SE)

(21) Appl. No.: 19/157,024

(22) PCT Filed: Feb. 16, 2024
(86) PCT No.: PCT/EP2024/053967

§ 371 Date: Aug. 15, 2025

(30) Foreign Application Priority Data
Feb. 17, 2023 (SE) 2350181-0

(51) Int. Cl. F16H 48/24; F16H 48/08; F16H 48/34

(52) U.S. Cl. CPC F16H 48/24; F16H 48/08; F16H 48/34

(57) ABSTRACT

A differential device including a cage, a carrier and a disconnect coupling having radially protruding splines configured to selectively connect the carrier to the cage. The radially protruding splines may be arranged on an axially moveable dog member. The radially protruding splines may be arranged in at least two parallel rows. The dog member may be arranged radially between the carrier and the cage.

### TECHNICAL FIELD

The present invention relates to differential devices, and in particular to a solution for disconnecting rotating parts of the differential device from the driveline.

### BACKGROUND

A differential device is normally arranged on vehicle axle for allowing the wheels of the axle to rotate at different speeds. The differential device comprises a ring gear receiving input drive torque, causing the ring gear to rotate. The ring gear is connected to a carrier which encloses planetary bevel gears, engaging driven bevel gears being attached to the respective wheel axles. As the planetary bevel gears can rotate around their respective axis, differential motion of the driven bevel gears is allowed.

It has been suggested to include a disconnect functionality to the differential in order to disengage the driven bevel gears (i.e. the respective wheels) from the transverse ring gear. One such example is described in WO2020178875, where the ring gear is connected to an outer case. An inner case, forming the carrier with the planetary and driven bevel gears, is connectable with the outer case by means of a clutch. The clutch is formed by a cylindrical member being axially moveable relative the outer case and having axially standing teeth facing mating axially disposed teeth of the inner case. By engaging the clutch the cylindrical member will move axially, causing the dog teeth to engage thereby connecting the ring gear, via the outer case, to the inner case.

While this prior art document suggests a solution which allows for the desired differential disconnect functionality, the axial engagement/disengagement of the dog teeth will cause a significant and disturbing noise. Consequently, there is a need for an improved differential device with disconnect functionality which provides for a smoother operation and reduces undesired sounds.

### SUMMARY

It is an object of the invention to at least partly overcome one or more of the above-identified limitations of the prior art.

According to a first aspect, a differential device is provided. The differential device comprises a cage, a carrier, and a disconnect coupling having radially protruding splines configured to selectively connect the carrier to the cage.

The radially protruding splines may be arranged on an axially moveable dog member.

The radially protruding splines may be arranged in at least two parallel rows.

The radially protruding splines may be arranged on a first side of the dog member, and wherein the dog member may further comprise a second set of splines on a second side.

The radially protruding splines may face the carrier and configured to selectively engage with mating splines of the carrier.

The second set of splines of the dog member may be in constant engagement with mating splines of the cage.

The dog member may be rigidly attached to a controllable sleeve.

According to a second aspect a differential device is provided. The differential device comprises a cage, a carrier, and a disconnect coupling having a dog member arranged radially between the carrier and the cage.

The dog member may be provided with radially protruding splines configured to selectively connect the carrier to the cage.

According to a third aspect, a vehicle is provided. The vehicle comprises a differential device according to the first or second aspects.

### BRIEF DESCRIPTION OF THE DRAWINGS

Embodiments of the invention will now be described, by way of example, with reference to the accompanying schematic drawings, in which

FIG. 1 is a cross sectional view of a differential device according to an embodiment;

FIGS. 2a-b are partly cross-sectional views showing the differential device of FIG. 1 in a connected mode;

FIGS. 3a-b are partly cross-sectional views showing the differential device of FIG. 1 in a disconnected mode; and

FIGS. 4a-b are enlarged cross-sectional views of parts of the differential device of FIG. 1.

### DETAILED DESCRIPTION

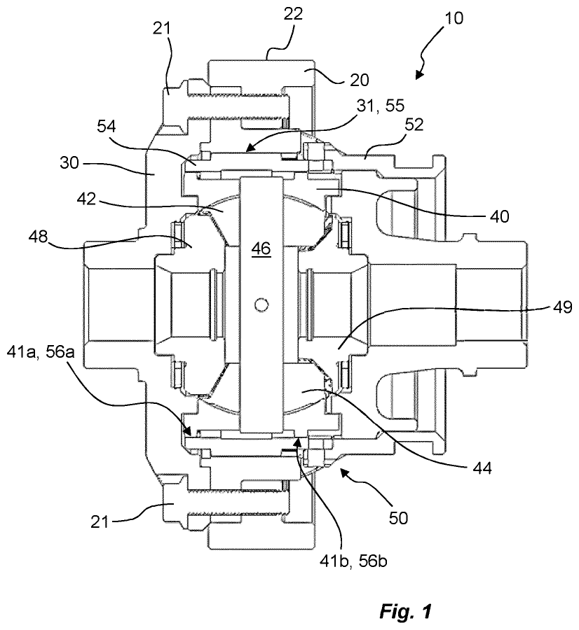

In FIG. 1 a differential device 10 is shown in cross-section. The differential device 10 comprises a ring gear 20 being securely fixed to a differential cage 30, e.g. by means of bolts 21. While the ring gear 20 is shown to have radial gears 22, it should be noted that it would also be possible to provide the ring gear 20 with bevelled gears. The ring gear 20 is configured to receive input torque from a torque source, e.g. an electric motor (not shown).

The differential cage 30 encloses a carrier 40. The carrier 40 has a cylindrical extension and carrier two opposite planetary bevel gears 42, 44. These planetary bevel gears 42, 44 are connected to the carrier 40 by means of a pin 46 extending through the carrier 40.

The planetary bevel gears 42, 44 are in engagement with two opposite driven bevel gears 48, 49. Each of the driven bevel gears 48, 49 is connected to a respective wheel axle (not shown).

The carrier 40 is selectively connected to the differential cage 30 by means of a disconnect coupling 50. The disconnect coupling 50 comprises an axially displaceable sleeve 52 arranged radially outside the differential cage 30. The disconnect coupling 50 further comprises a cylindrical dog member 54 being fixed to the sleeve 52, such that axial movement of the sleeve 52 causes a corresponding axial movement of the dog member 54.

An actuator (not shown) is provided for controlling the disconnect device 50. Preferably, the actuator is an electromechanical actuator having an eccentric pin inserted into a slot of the sleeve 52. Upon actuation, the actuator will cause the pin to rotate, thereby causing it to move also axially due to the eccentric configuration. Maximum translation of the sleeve 52 can thus be achieved by rotating the pin ±90°, or less.

It should however be noted that other actuators may replace the above-mentioned example utilizing the eccentric pin; as possible option, a ball ramp mechanism or a hydraulic piston could be considered for controlling the disconnect device 50.

The dog member 54 is arranged radially between the carrier 40 and the cage 30. The dog member 54 has outer splines 55 engaging with mating splines 31 on the inner surface of the cage 30.

The dog member 54 is further provided with inner splines 56a-b selectively engaging with mating outer splines 41a-b of the carrier 40.

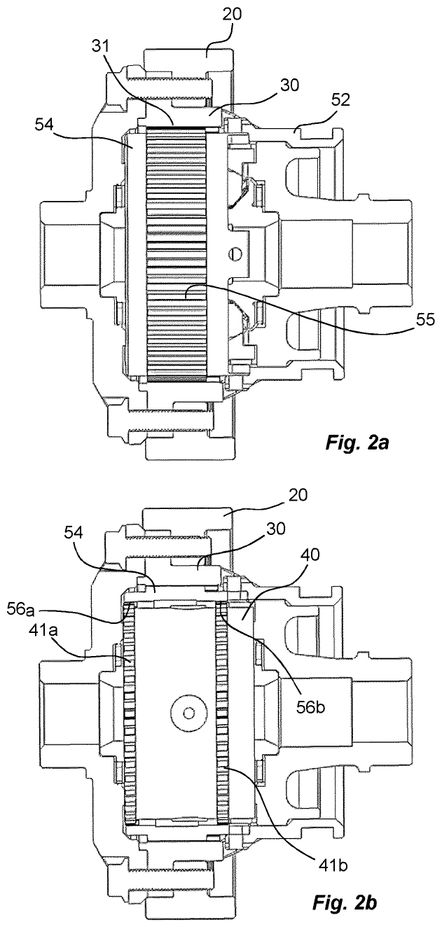

Now turning to FIGS. 2a-b, the differential device 10 is shown in a state where the disconnect coupling 50 is connected, i.e. the carrier 40 is rotationally connected to the cage 30.

In FIG. 2a the outer surface of the dog member 54 is shown. The outer splines 55 has an axial extension exceeding the maximum axial distance by which the dog member 54 is moveable. Hence the splines 55, protruding radially out from the dog member 54, will always be in engagement with the inner splines 31 of the cage 30.

In FIG. 2b the outer surface of the carrier 40 is shown. Two rows of splines 41a-b are arranged at the lateral ends of the carrier 40. The splines 41a-b protrude radially and engages with the corresponding inner rows of splines 56a-b of the dog member 54.

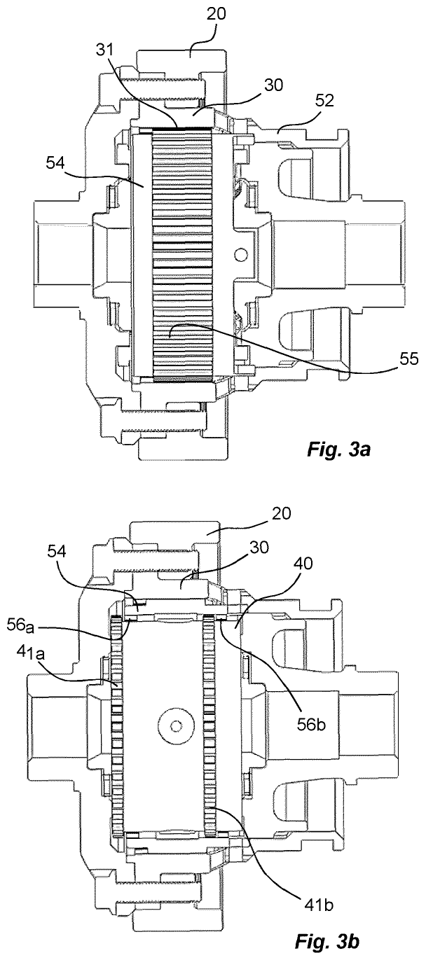

Now turning to FIGS. 3a-b, the differential device 10 is shown in a state where the disconnect coupling 50 is disconnected, i.e. the carrier 40 is free to rotate relative to the cage 30.

In FIG. 3a the outer surface of the dog member 54 is shown, i.e. this figure corresponds to FIG. 2a however the sleeve 52 and the dog member 54 have been axially moved to the right. The outer splines 55 of the dog member 54 are still in engagement with the inner splines 31 of the cage 30.

In FIG. 3b the outer surface of the carrier 40 is shown, i.e. this figure corresponds to FIG. 3a however the sleeve 52 and the dog member 54 have been axially moved to the right. The two rows of splines 56a-b have been axially displaced so they are no longer engaging with the outer splines 41a-b of the carrier 40.

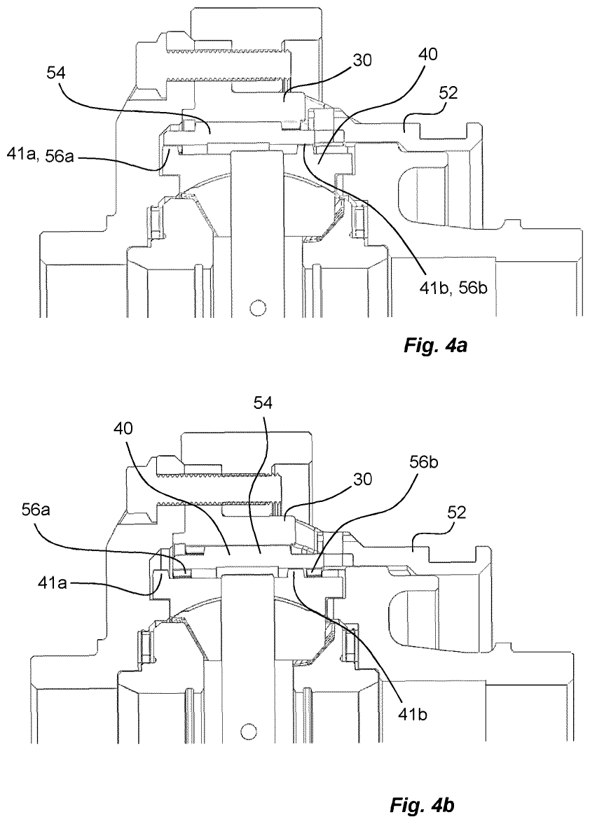

Cross-sectional views of the disconnect coupling 50 are given by FIGS. 4a-b. As is clear from FIG. 4a, showing the connected state of the disconnect coupling 50, the sleeve 52 is moved to the left to reach its end position, which corresponds to a position of the dog member 54 where the spline rows 56a-b are engaging with the rows of splines 41a-b of the carrier 40.

In FIG. 4b the sleeve 52 is moved to the right to reach its opposite end position, which corresponds to a position of the dog member 54 where the spline rows 56a-b are axially moved out of contact with the rows of splines 41a-b of the carrier 40.

Although the invention has been described with reference to the specific example shown in the figures, it should be noted that in some embodiments it would be possible to arrange the splines 55, 56a-b of the dog member 54 in an opposite manner, i.e. so that the dog member 54 is always connected with the carrier 40 while selective connection is instead established with the cage 30.

Such configuration would then require the outer spline configuration of the carrier to be repositioned to the inner side of the cage 30, and vice versa.

From the description above follows that, although various embodiments of the invention have been described and shown, the invention is not restricted thereto, but may also be embodied in other ways within the scope of the subject-matter defined in the following claims.

1. A differential device, comprising a cage, a carrier and a disconnect coupling having radially protruding splines configured to selectively connect the carrier to the cage.

2. The differential device according to claim 1, wherein the radially protruding splines are arranged on an axially moveable dog member.

3. The differential device according to claim 2, wherein the radially protruding splines are arranged in at least two parallel rows.

4. The differential device according to claim 2, or 3, wherein the radially protruding splines are arranged on a first side of the dog member, and wherein the dog member further comprises a second set of splines on a second side.

5. The differential device according to claim 4, wherein the radially protruding splines are facing the carrier and configured to selectively engage with mating splines of the carrier.

6. The differential device according to claim 4, wherein the second set of splines of the dog member are in constant engagement with mating splines of the cage.

7. The differential device according to claim 6, wherein the dog member is rigidly attached to a controllable sleeve.

8. A differential device comprising a cage, a carrier and a disconnect coupling having a dog member arranged radially between the carrier and the cage.

9. The differential device according to claim 8, wherein the dog member is provided with radially protruding splines configured to selectively connect the carrier to the cage.

10. A vehicle, comprising the differential device according to claim 1.

11. The differential device according to claim 2, wherein the radially protruding splines are arranged on a first side of the dog member, and wherein the dog member further comprises a second set of splines on a second side.

12. The differential device according to claim 11, wherein the radially protruding splines are facing the carrier and configured to selectively engage with mating splines of the carrier.

13. The differential device according to claim 11, wherein the second set of splines of the dog member are in constant engagement with mating splines of the cage.

14. The differential device according to claim 2, wherein the dog member is rigidly attached to a controllable sleeve.
